(19) United States
(12) Patent Application Publication
(10) Pub. No.: US 2008/0255932 A1
(43) Pub. Date: Oct. 16, 2008

(54) Method for Enticing Computer Users to Return to an Electronic Commerce Portal

(76) Inventors: Kenneth D. Timmons, Raleigh, NC (US); Philip L. Childs, Raleigh, NC (US); Howard Locker, Cary, NC (US); Michael T. Vanover, Raleigh, NC (US)

Correspondence Address: DILLON & YUDELL LLP, 8911 N. CAPITAL OF TEXAS HWY, SUITE 2110, AUSTIN, TX, 78759, US

(21) Appl. No.: 11/734,590

(22) Filed: Apr. 12, 2007

(51) Int. Cl. G06Q 30/00

(52) U.S. Cl. 705/14

(57) ABSTRACT

A method for enticing computer users to return to an electronic commerce portal is disclosed. In response to a user registering to a merchant server for the first time, a unique number is associated with the user. Hardware information is then obtained from a computer utilized by the user. A digital certificate is generated by encrypting the unique number along with the obtained hardware information. The digital certificate is subsequently sent to the user computer for generating a unique customer number to be displayed on a web page of the user computer. On a periodic basis, the merchant server sends a master number to the user computer to be displayed on a web page of the user computer. In response to a notification of the master number matches the unique customer number on the user computer, a prize claiming process can be initiated.

### BACKGROUND OF THE INVENTION

1. Technical Field

The present invention relates to electronic commerce in general, and, in particular, to electronic commerce over the Internet. Still more particularly, the present invention relates to a method for enticing computer users to return to an electronic commerce portal on the Internet.

2. Description of Related Art

An electronic commerce (e-commerce) portal typically provides a single Internet access point for a collection of e-commerce websites. In a sense, the e-commerce portal is the electronic equivalent of a shopping mall with each e-commerce website being equivalent to a store inside the shopping mall.

The value of an e-commerce portal is generally determined by the frequency of computer users accessing the e-commerce portal and how much money computer users spend directly or indirectly as a result of passing through the e-commerce portal. Successful e-commerce portal providers entice computer users to return to their e-commercial portals and spend money on a consistent basis. The “stickyness” of an e-commerce portal is basically determined by the value from which computer users may derive, and such value can be entertainment, informational, productivity, or convenience. As much as an e-commerce portal provider would like computer users to visit the e-commerce portal on a regular basis, the problem is that it is very easy for computer users to replace the e-commerce portal with another website because computer users eventually becomes enamored with another website and may never come back to the e-commerce portal. As a result, the money stream of the e-commerce portal is lost.

One known solution to the above-mentioned problem is to impose an e-commerce portal as the default home page independent of the desire of computer users. This method is seldom, if ever, appreciated by computer users. Another solution is to use pop-up dialog boxes to ask computer users on a regular basis as to whether they want the e-commerce portal to be their default home page. This method is slightly less intrusive but still not well received by computer users in general.

Consequently, it would be desirable to provide an improved method for enticing computer users to return to an e-commerce portal.

### SUMMARY OF THE INVENTION

In accordance with a preferred embodiment of the present invention, in response to a user registering to a merchant server for the first time, a unique number is associated with the user. Hardware information is then obtained from a computer utilized by the user. A digital certificate is generated by encrypting the unique number along with the obtained hardware information. The digital certificate is subsequently sent to the user computer for generating a unique customer number to be displayed on a web page of the user computer. On a periodic basis, the merchant server sends a master number to the user computer to be displayed on a web page of the user computer. In response to a notification of the master number matches the unique customer number on the user computer, a prize claiming process can be initiated.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a network computing environment in which a preferred embodiment of the present invention is incorporated;

FIG. 2 is a block diagram of various software components within a merchant server within the network computing environment from FIG. 1, in accordance with a preferred embodiment of the present invention;

FIG. 3 is a block diagram of various software components implemented in a customer computer within the network computing environment from FIG. 1, in accordance with a preferred embodiment of the present embodiment; and

FIG. 4 is a high-level logic flow diagram of a method for enticing computer users to return to an electronic commerce portal, in accordance with a preferred embodiment of the present embodiment.

### DETAILED DESCRIPTION OF A PREFERRED EMBODIMENT

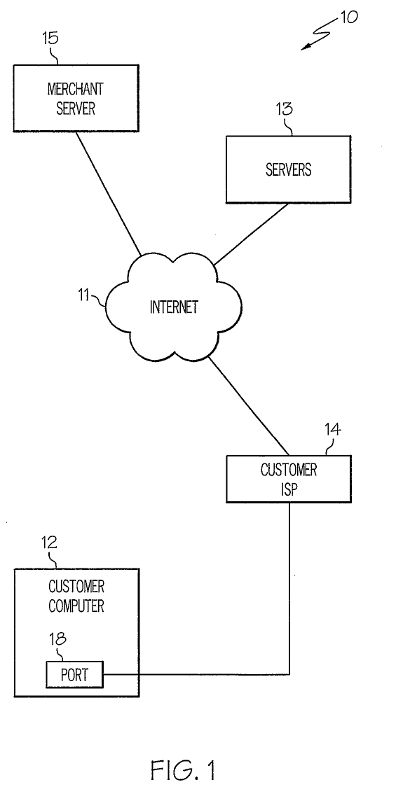

Referring now to the drawings and in particular to FIG. 1, there is depicted a block diagram of a network computing environment in which a preferred embodiment of the present invention is incorporated. As shown, a network computing environment 10 includes a group of servers 13, a merchant server 15, a customer Internet Service Provider (ISP) 14 and at least one customer computer 12. Merchant server 15 and servers 13 may be any computer system capable of maintaining files and making such files accessible to customer computer 12. Customer computer 12 may be any computer system, such as a desktop computer, a notebook computer, etc., capable of executing a browser program. Customer computer 12 includes a communication port 18 for connecting a customer to customer ISP 14. A customer is any person interested in obtaining information and/or purchasing products from merchant server 15. Customer computer 12 also includes an input device, such as a keyboard, a mouse, a pen stylus, etc., through which a customer may input data to control the operation of a browser program.

Merchant server 15 implements an electronic commerce (e-commerce) website where customers can obtain information on the merchant's products and purchase products on-line using a secure connection via customer computer 12. Customer computer 12 may use customer ISP 14 to access Internet 11 for general Internet “surfing” and to connect to merchant server 15.

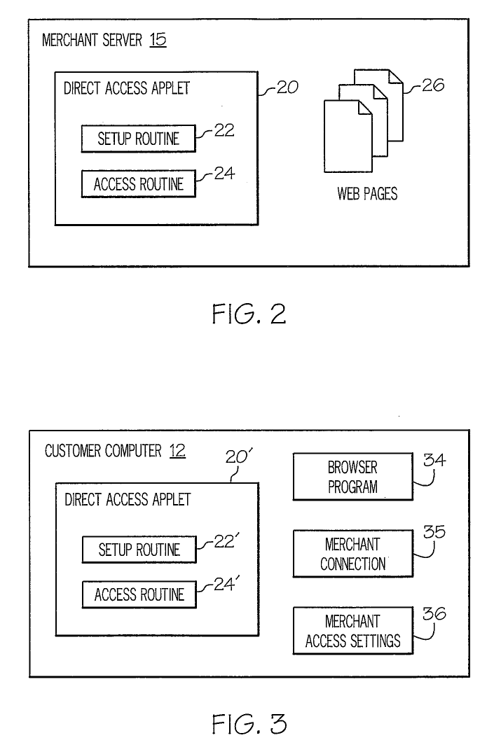

With reference now to FIG. 2, there is illustrated a block diagram of various software components within merchant server 15 from FIG. 1, in accordance with a preferred embodiment of the present invention. As shown, merchant server 15 maintains a direct access applet 20 having a setup routine 22 and an access routine 24. Direct access applet 20, which may be written as a Java® applet or any in other computer programming language, is capable of being executed by a browser program on a customer computer such as customer computer 12 from FIG. 1.

Merchant server 15 also includes various web pages 26 that can be downloaded over the Internet by a browser program on a customer computer. Web pages 26 implement an e-commerce website, and may be comprised of any multimedia content known in the art, such as hypertext markup language (HTML) pages, extensible markup language (XML) pages, video, image, text file, sound file, etc.

Referring now to FIG. 3, there is illustrated a block diagram of various software components within customer computer 12 from FIG. 1, in accordance with a preferred embodiment of the present embodiment. Customer computer 12 includes a browser program 34 for retrieving files from a server, such as merchant server 15 or other servers 13 from FIG. 1, over the Internet. Browser program 34 and servers 13, 15 may communicate with each other using a document transfer protocol, such as HTTP, File Transfer Protocol, Gopher, etc.

Customer computer 12 also includes direct access applet 20′ that can be downloaded from a merchant server, such as merchant server 15 from FIG. 2, using browser program 34. Direct access applet 20′ includes a setup routine 22′ for setting up a merchant connection program 35 to execute within customer computer 12 in order to access merchant server 15. Setup routine 22′ generates merchant access settings 36 that merchant connection 35 accesses during the establishment of a connection with customer ISP 14 (from FIG. 1). Access settings 36 may be stored in the operating system registry file or in a file within a non-volatile storage medium (not shown) within customer computer 12. Direct access applet 20′ may only include an access routine 24′ if merchant server 15 detects that customer computer 12 already has merchant connection 35 installed, which may be detected by placing a cookie on customer computer 12.

In accordance with a preferred embodiment of the present invention, a unique certificate is generated within merchant server 15 after a customer has initially registered with merchant server 15 via an e-commerce portal provided by merchant server 15. Each unique certificate includes user information such as time and date along with an n digit random number. Each unique certificate is also signed with a private key to validate that it is a genuine portal certificate from merchant server 15. The user information and the n digit random number of an unique certificate can be made visible to a customer computer via a gadget within a browser program executing within the customer computer. The e-commerce portal also provides specific benefits that are awarded to a registered customer having a unique certificate that matches a master number randomly generated by merchant server 15.

A catalog of potential prizes can be made visible along with the gadget. When a user sees a match between the master number and the user's own certificate number, the user can initiate the prize claim process. With the hope of winning a prize, the user is inclined to stay on the e-commerce portal for as long as it is practical, and the user is more likely to come back to the e-commercial portal in the future.

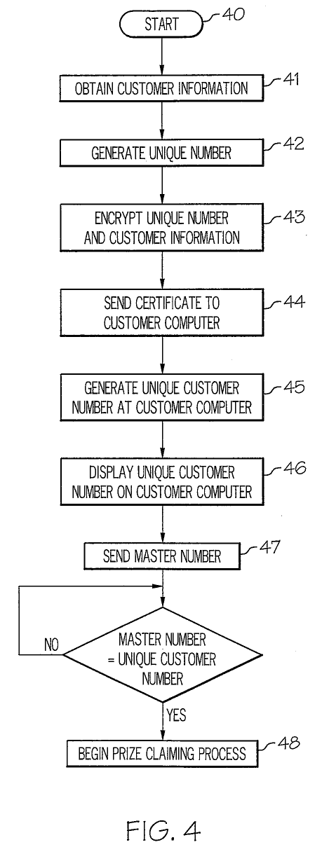

With reference now to FIG. 4, there is depicted a high-level block diagram of a method for enticing computer users to return to an e-commerce portal, in accordance with a preferred embodiment of the present invention. Starting at block 40, in response to a customer registering to an e-commerce portal using a username/password combination for the first time, customer information related to a customer computer (such as customer computer 12 from FIG. 1) are obtained, as shown in block 41. The customer information related to the customer computer, which may include a machine type, a model number, and a serial number, can be obtained from the customer computer via ActiveX controls or Java applets. A unique number is randomly generated within a merchant server (such as merchant server 15 from FIG. 1) for the customer, as depicted in block 42. Preferably, the unique number is 1024-bit long at a minimum.

The unique number along with the machine type, the model number and the serial number of the customer computer are then encrypted via a digital signature process to generate a unique signature key and a unique certificate, as shown in block 43. The unique signature key is stored within the merchant server, but the unique certificate is sent from the merchant server to the customer computer to be stored within the customer computer, as depicted in block 44.

Next, a unique customer number is generated at the customer computer by using the unique certificate received from the merchant server, as shown in block 45. The unique customer number is displayed within a web browser on the customer computer whenever the customer logs on to the merchant server using the above-mentioned username/password combination, as depicted in block 46. In addition, after the customer has logged on to the merchant server using the above-mentioned username/password combination, the merchant server sends a master number to the customer computer on a periodic basis, as shown in block 47. The master number is changed on a regular time interval, such as every five minutes, and is preferably sent from the merchant server to the customer computer via a relatively simple synchronization (RSS) feed. In order to assist the customer to easily discern the difference between the master number and the unique customer number, and the master number sent from the merchant server is preferably displayed directly on top of (i.e., overlay) the unique customer number.

At this point, the customer can determine whether or not the master number sent from the merchant server matches the unique customer number from the customer computer. The overlapping numbers should allow the customer to realize whether or not the two numbers match with each other via a quick glance. When the customer notices the numbers match each other, the customer can initiate the prize claiming process by clicking a special button on the web page. In response to the customer clicking the special button on the web page, the merchant server can begin processing the prize claim for the customer, as depicted in block 48.

As has been described, the present invention provides a method for enticing customers to return to an e-commerce portal. With the present invention, the amount of prize opportunity to number of customers (or players) at any given time can be very small but still effective if the prizes are valuable. Since each customer decides to come back to the e-commerce portal under the customer's own volition; thus, the customer is more motivated to participate.

It is also important to note that although the present invention has been described in the context of a fully functional computer system, those skilled in the art will appreciate that the mechanisms of the present invention are capable of being distributed as a computer program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for enticing computer users to return to an electronic commerce portal, said method comprising:
in response to a user registering to a merchant server for the first time, associating a unique number with said user;
obtaining hardware information from a computer utilized by said user;
generating a digital certificate by encrypting said unique number along with said obtained hardware information;
sending said digital certificate to said computer for generating a unique customer number to be displayed on a web page of said computer;
sending a master number from said merchant server to said computer on a regular basis, wherein said master number is to be displayed on said web page of said computer; and
in response to a notification of said master number matches said unique customer number from said computer, initiating a prize claiming process.

2. The method of claim 1, wherein said user registering further includes registering with a username and a password.

3. The method of claim 1, wherein said hardware information includes a machine type, a model number, and a serial number.

4. The method of claim 1, wherein said hardware information further includes a time and day on which said user registered with said merchant server.

5. The method of claim 1, wherein said method further includes displaying said master number directly on top of said unique customer number within a web page.

6. The method of claim 1, wherein said notification includes clicking on a predetermined area within a web page.

7. A computer usable medium having a computer program product for enticing computer users to return to an electronic commerce portal, said computer usable medium comprising:
computer program code for, in response to a user registering to a merchant server for the first time, associating a unique number with said user;
computer program code for obtaining hardware information from a computer utilized by said user;
computer program code for generating a digital certificate by encrypting said unique number along with said obtained hardware information;
computer program code for sending said digital certificate to said computer for generating a unique customer number to be displayed on a web page of said computer;
computer program code for sending a master number from said merchant server to said computer on a regular basis, wherein said master number is to be displayed on said web page of said computer; and
computer program code for, in response to a notification of said master number matches said unique customer number from said computer, initiating a prize claiming process.

8. The computer usable medium of claim 7, wherein said user registering further includes registering with a username and a password.

9. The computer usable medium of claim 7, wherein said hardware information includes a machine type, a model number, and a serial number.

10. The computer usable medium of claim 7, wherein said hardware information further includes a time and day on which said user registered with said merchant server.

11. The computer usable medium of claim 7, wherein said computer usable medium further includes computer program code for displaying said master number directly on top of said unique customer number within a web page.

12. The computer usable medium of claim 7, wherein said notification includes clicking on a predetermined area within a web page.
